(19) United States
(12) Patent Application Publication
(10) Pub. No.: US 2024/0418562 A1
(43) Pub. Date: Dec. 19, 2024

(54) ELECTRONIC STATIC WEIGHING SCALE WITH TERMINAL INCLUDING OPERATOR IDENTIFICATION SYSTEM AND OPERATOR INTERACTION SYSTEM

(71) Applicant: RADWAG WAGI ELEKTRONICZNE WITOLD LEWANDOWSKI, Radom (PL)

(72) Inventor: Pawel PEKALA, Radom (PL)

(21) Appl. No.: 18/689,865

(22) PCT Filed: Nov. 4, 2022
(86) PCT No.: PCT/PL2022/050076

§ 371 Date: Mar. 7, 2024

(30) Foreign Application Priority Data
Nov. 5, 2021 (PL) P.439430

(51) Int. Cl. G01G 21/28

(52) U.S. Cl. CPC G01G 21/283

(57) ABSTRACT

An electronic static weighing scale with a terminal, comprising an operator identification system and an operator-device interaction system, wherein the weighing terminal (2) has a housing situated horizontally on the measuring table, consisting of two elements, an upper housing part (3) and a lower housing part (4) arranged. The upper housing part (3) is located on the lower housing part (4) in such a way that their side parts are in contact with each other. The upper part of the housing (3) is equipped with a graphic display with a touch panel (5), which covers most of the surface of the upper part of the housing (3). The lower part of the terminal housing (4) has a raised elevation with a flat surface matching an integrated circuit surface on the weighing terminal's computer and these surfaces are in contact.

The subject of the invention is an electronic static weighing scale with a terminal equipped with a cooling system with a system for identifying the operator and interacting with the operator.

Various design solutions of scales with terminals and indicators are known. An exemplary solution of an analytical balance with a weighing terminal is shown in patent U.S. Pat. No. 6,531,665B2 from Mettler-Toledo GmbH. The terminal has a large display and keyboard as well as the possibility of adjusting the display tilt and the possibility of connecting to a scale.

In turn, the patent application EP2416131A1 from Mettler Toledo Albstadt GmbH shows an industrial scale with a strain gauge strain sensor under the weighing pan and an indicator with the possibility of connecting such a sensor to an analog-to-digital converter.

The indicator and terminal solutions presented above do not reveal the specific technical means needed for efficient cooling of the systems, possibly because they are not needed for the given technical solutions.

Patent application CN112484833 reveals a high-tech weighing terminal with technical means for heat dissipation through ventilation. For this purpose, ventilation holes are arranged in the terminal housing and a fan is placed inside one of the chambers of the terminal housing in order to intensify the heat dissipation.

The development of technology entails the increasing technical requirements for terminals and weighing indicators used to build weighing scales. The application of various up-to-date technologies available in the broadly understood computer technology causes development of systems and greater demands as to the computing capabilities of the central units used in the terminals.

In this patent description, the terminology from the EN 45501:2015 standard has been used. This standard defines a weighing terminal as a device containing the main display for the presentation of measurement results and communication with the operator, a keyboard or its substitute, and optionally some software functions for processing measurement data without the scaling function. On the other hand, the weighing indicator, in addition to the features of the weighing terminal, also includes an analog-to-digital converter and software scaling of measurement data. Since the terminal, in the understanding of this standard, is the part of the indicator, all of the following issues related to the terminal automatically apply to the weighing indicator as well.

Terminals and weighing indicators with the software used in them more and more resemble modern computers or smartphones. This is followed by temperature problems due to the heat generated by the CPU and other integrated circuits inside the device housing. A point source of a significant amount of heat inside the terminal housing is disadvantageous and can lead to malfunction of other systems inside the common housing and to faster aging of some components, e.g., faster aging graphic display or electrolytic capacitors. Measurement systems are particularly sensitive to the amplitude of temperature changes. In the case of a strain gauge, where the terminal is also a weighing indicator containing an analog-to-digital converter, the temperature variation in the vicinity of the converter is a source of measurement errors. In this case, it is important not only to remove heat outside, in order to reduce the maximum temperature, but also to limit the amplitude of temperature changes, i.e. ensure effective heat dissipation. The use of all kinds of mechanical ventilation has the disadvantage of generating mechanical vibrations that can be transferred to the weighing pan and generate additional measurement errors. In the case of laboratory balances with the highest accuracy, the problem may also be the air stream generated by the fan, which causes additional air movement around the balance, which is an additional source of errors. Therefore, modern terminals, which are a component of scales, must be equipped with an efficient cooling system, which is designed not only to reduce the maximum temperature by radiating heat to the outside, but also to dissipate the heat inside by reducing the amplitude of temperature changes without the use of mechanical ventilation.

The purpose of this invention is an electronic static weighing scale with a terminal, containing an operator identification system and a system for interaction with the operator, a graphic display with a touch panel connected to the upper part of the two-part terminal housing, consisting of an upper and a lower part, the lower part of which is at least partially made of heat-conducting material. In this housing there is a weighing terminal's computer in the form of a printed circuit board with a set of interfaces and at least one integrated circuit requiring cooling, an operator identification system and a contactless operator-device interaction system. The inner surface of the lower part of the terminal housing has at least one raised elevation with a flat surface to match at least one integrated circuit on the weighing terminal's computer board, and the surfaces of the integrated circuits and the raised elevations are in touch or in contact via a heat conducting material.

The disclosed solution consists in transforming the part of the weighing terminal housing with the display, which is a component of the electronic scale, into a heat sink with a high heat capacity, capturing and dissipating heat to the outside. The present invention relates to weighing scales with a terminal closed in a flat housing, the maximum height of which during typical use, when positioned at the workplace, is significantly smaller than the other dimensions, i.e. length and width. A minimum threefold difference in these dimensions is considered significant. It is assumed that these types of terminals lie on a flat surface with the display facing upwards during operation, and this position is assumed in all terms relating to the positioning of elements in space, such as e.g. top, bottom, side etc. The terms: back, front, left and right sides are understood to be seen from the position of an operator, standing in front of the balance with the terminal, facing the balance, and the terminal is positioned in such a way that the operator can see the image on the display in the correct non-inverted and unturned position.

The graphic display with a touch panel occupies the upper part of the housing in whole or in a significant part. On the edging of the display, in the frame of the top of the housing surrounding the display there may be situated other components and sensors for interaction with the operator, but these may be situated on the side of the housing as well e.g. proximity sensor, fingerprint reader, microphone, RFID reader, etc. On the sides of the housing, in the upper or lower part, there may be openings for communication interfaces in the form of sockets. The upper and lower housing parts are shaped to have all four side portions facing downward in the case of the upper part and facing upward in the lower housing part. The upper part of the housing is located on the lower part in such a way that their side parts are in contact with each other. The lower part of the housing is understood to be a part which stands on a flat working surface together with other components of the weighing scale and is made at least in part of a material that conducts heat well. The upper and lower housing parts are mechanically connected to each other. This can be a kind of screw or clamp connection.

Since the location of the radiation part in the lower part of the housing is not favorable, due to the natural upward movement of the heated air, the heat sink has a large heat capacity and heat dissipation outside and inside the housing, in accordance with the assumption that the most unfavorable for the device is especially high temperature at single points inside the housing. The lower part of the housing has radiation fins. They are located on the sides of the lower housing and in the base of the lower housing. The lower part of the housing has means for adjusting the tilt of the terminal and the distance between the terminal and the ground providing a ventilation corridor for removing heat from under the terminal in the form of at least one adjustable foot. The inner surface of the lower housing part has a raised elevation or elevations with flat surface to fit at least one integrated circuit on the main circuit board of the weighing terminal's computer. After assembling, the surfaces of the integrated circuits and the elevated surfaces on the lower part of the housing are in contact with each other. This means that the cooled integrated circuits are placed on the side of the board facing downward when mounting the terminal. Between these surfaces, it is assumed that a heat-conducting material with appropriate plasticity is used to match the surfaces, e.g. in the form of a tape, paste or a thermally conductive adhesive. It is also possible for a cooled integrated circuit to have its own heat sink, and then the heat sink contacts a flat surface on the elevation of the inner surface of the lower housing.

Conventional weighing indicators and terminals, including those showed above in the description of the prior art, that are parts of weighing scales are equipped with arrays of buttons, keyboards and/or touch panels. If the scale is equipped with advanced software, it usually has an operator identification system implemented by logging in. A typical operator login process requires at least a password. In addition, all kinds of interaction with the scale program also involve pressing the surface of the weighing terminal. The username is either entered or searched in the operator database. Such an operation requires direct mechanical interaction with the terminal. It is also a kind of an indirect mechanical effect on the ground on which the balance is situated. In the case of the most accurate balances, where the measurement resolution is determined in micrograms, this type of interaction, even if there is no weighing at the moment, leads to larger measurement errors. Each vibration and deformation of the work surface between the measurements may slightly change the mechanical condition of the balance and affect, at least, the repeatability of the measurements.

Another source of error in the most accurate scales is the operator's body temperature. In the case of the most accurate measurements, especially the change of the situation, i.e. the approach of the operator to the balance after the break, changes the ambient temperature around the balance and brings in interaction between the thermal radiation of the operator and the device, which is another reason for moving the operator away from the balance.

The internal computer of the weighing terminal cooperates with internal readers and sensors to form the following systems: identification system, contactless interaction system with the operator.

The identification system is equipped with a camera, fingerprint reader, RFID tag reader. This system is intended mainly for operator identification, but it can also be used for other types of identification, e.g. weighed objects equipped with RFID tags. These capabilities allow the terminal software to enable multi-level operator identification using at least two identification sensors, e.g. the operator reads his RFID card in and then scans the fingerprint.

The non-contact operator interaction system is equipped with a camera, microphone and at least one optical proximity reader. This system enables the operator to communicate with the scale without touching it, e.g. by means of gestures recognized by a camera and/or proximity sensors and/or voice commands given by the operator. Equipping the system with a loudspeaker enables feedback. The scale can transmit e.g. a measurement result or possible actions to be performed at a given moment by means of voice commands using the loudspeaker.

The disclosed solution of a balance with a terminal attempts to be a remedy to the above problems by moving the operator away from the balance, which reduces the mechanical interaction and minimizes the thermal interaction.

The details of the invention are shown in the embodiment in the drawing, where:

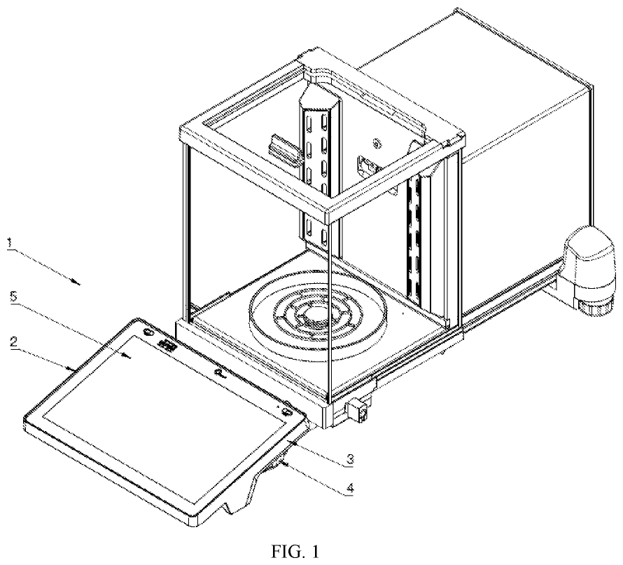

FIG. 1 presents the balance with the terminal in an axonometric view,

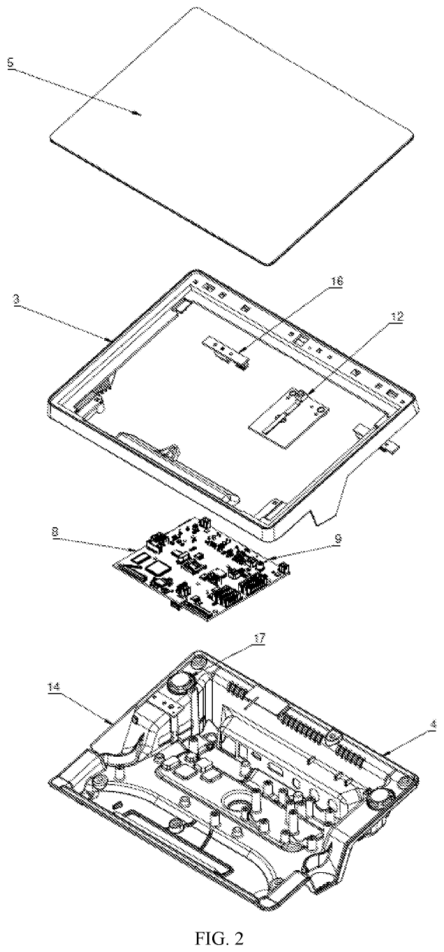

FIG. 2 presents an axonometric view of the outer part of the lower part of the weighing terminal housing,

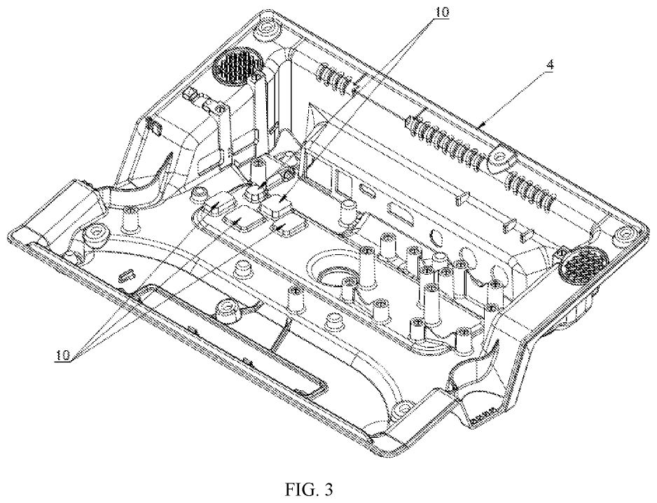

FIG. 3 presents the structure of the terminal in an explosive view,

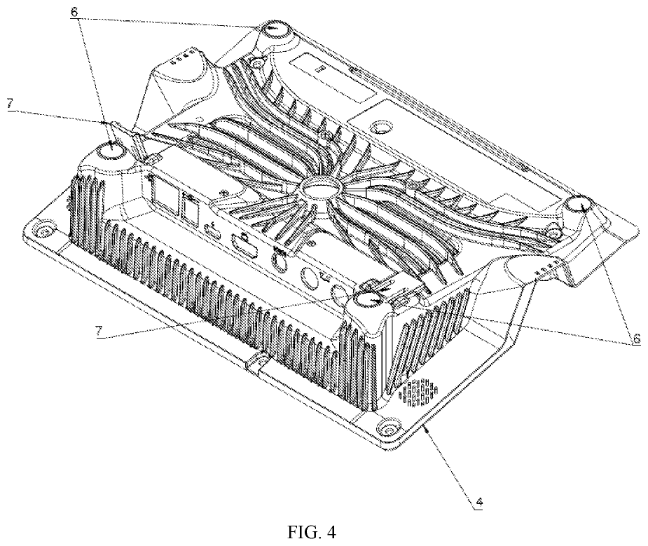

FIG. 4 presents an axonometric view of the inner part of the lower housing of the weighing terminal,

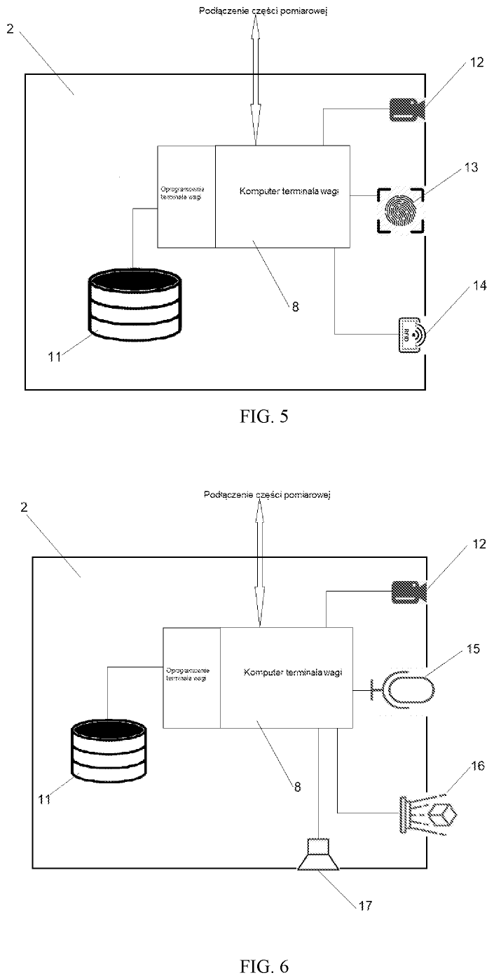

FIG. 5 presents a block diagram of the operator identification system in the weighing terminal,

FIG. 6 presents a block diagram of the contactless interaction system with the operator.

The electronic static balance 1, being the subject of this invention, with weighing terminal 2 is shown in FIG. 1. The weighing terminal 2 has a flat housing placed horizontally on a measurement table, consisting of two elements, an upper housing part 3 and a lower housing part 4 situated one on top of the other. The upper housing part 3 and the lower housing part 4 are shaped to have all four side portions facing downward in the case of the upper housing part 3 and facing upward in the case of the lower housing part. The upper housing part 3 is situated on the lower housing part 4 in such a way that their side portions are in contact with each other the way that the side portions of the upper housing part 3 are positioned on the side portions of the lower housing part 4. The upper housing part 3 is equipped with a graphic display with a touch panel 5 that covers most of the surface of the top of the upper housing 3. As shown in FIG. 2, the lower part of the housing 4, which forms the basis of the housing of the weighing terminal 2, is set on the ground by means of fixed feet 6 being part of the lower part of the housing and adjustable supports 7 connected to the lower part of the housing 4, on which supports the weighing terminal 2 is placed. Inside the terminal 2, as shown in FIG. 3, there is a weighing terminal's computer 8 and a set of interfaces 9 accessible to the outside through openings in the housing, in the case of the presented solution through openings in the rear part of the weighing terminal 2 housing. In the presented solution, the computer of the weighing terminal 8 and the set of interfaces 9 are made within one printed circuit board. The inner surface of the lower part of the housing 4, shown directly in FIG. 4, is shaped in such a way that it has at least one raised elevation with a flat surface 10 matching with at least one integrated circuit on the main computer board of the weighing terminal 8 in such a way that when assembled, the surfaces of the integrated circuits and the raised elevation 10 are in parallel contact with each other, preferably via a heat-conducting material.

The lower part of the housing 4 acts as a heat sink, therefore it is made of a material that conducts heat well. Metals advantageous in heat dissipation are primarily copper and aluminum, but in the presented embodiment, each metal used for the housing of devices is sufficient, provided that the housing coating, if it is made, is also a good heat conductor. The lower part of the housing 4 may be made of metal, but polymers that conduct heat well are also known, which makes it possible to use them in this case. It is also possible to make this housing part only partially of a good heat conductor.

The lower housing part 4 and the upper housing part 3 are connected by screw connections through the openings in the lower part of the housing to the holes in the upper part of the housing. The holes in the upper part of the plastic housing align with the screws so that a thread is created in them. In the presented example, six screw connections are used, three at the rear edge of the lower housing part 4 and three closer to the front edge of the lower housing part 4.

The lower part of the housing 4 has at least one adjustable support 7 connected to its lower part, which, resting on a flat surface, forms a space between this surface and the surface of the lower housing part. In the simplest case, the terminal rests on one of the edges and on the adjustable support 7. In the case of the presented embodiment, near the front and rear edges of the housing, there are fixed-length feet 6, two at each edge, forming a quadrangle. They form a plane on which the weighing indicator 2 is positioned during operation. This plane is parallel to the lower part of the housing 4. At the feet 6 situated in the rear part of the lower part of the housing 4 there are two identical adjustable supports 7 with a strongly flattened shape having two positions, closed position when their surface cling the lower surface of the lower part of the housing 4 and they are not used, and open position when the supports 7 are at a minimum angle of 60 degrees from the lower surface of the lower housing 4 when they replace the feet 6 located at the rear of the lower housing 4. Since the supports 7 are longer than the feet 6, they are used in the open position to support the weighing indicator 2 on a work surface. The connection between the supports 7 and the lower part of the housing 4 is carried out by swivel joint, without additional bearing elements. The flat supports 7 have lateral protrusions close to their edges extending to the sides in one axis in the plane of the support, which press fit into the holes in the recesses in the surface of the lower part of the housing. These recesses form two side planes in which these openings are made, and a transverse plane parallel to the axis of rotation of the supports, supporting the supports 7 set in the open position. An extension of this side plane are the feet 6 located closer to the rear edge of the lower part of the housing 4. In the open position, the supports 7 are pressed by the force of the terminal's gravity against these transverse planes and against the feet 6, thus forming a new foot of greater length and changing the angle of inclination of the terminal in forward direction. This change also increases the space under the terminal and improves cooling conditions due to the fact that the plane of the lower part of the housing 4 is no longer parallel to the ground and is inclined at an angle, which facilitates the movement of the lighter heated air towards the higher elevated side.

In the drawing, FIG. 5 shows an exemplary embodiment of the operator identification system in the weighing terminal 2 on a block diagram. The system is based on a database 11, containing at least a list of operators and at least one of the sensors for operator verification, i.e. camera 12, fingerprint reader 13 and/or RFID tag reader 14. The verification sensors are connected to the computer of the weighing terminal 8 cooperating with the operator's database contained in the weighing terminal 11 database, including appropriate patterns characterizing operators. In the case of the camera 12, these are sets of facial features, in the case of the fingerprint reader 13, they are finger presses, and in the case of the RFID tag reader 14, these are tag codes that characterize individual operators. The use of more than one verification sensor allows for multi-level operator verification.

In the drawing, FIG. 6 shows a block diagram of a contactless operator interaction system in the weighing terminal 2 on a block diagram. The system is based on at least one sensor for contactless interaction of the terminal 2 with an operator. It is a camera 12, a microphone 15, and/or at least one optical proximity sensor 16. The camera 12 and the proximity sensor 16 provide for gesture recognition. The microphone 15 is used to transmit voice commands to the computer of the weighing terminal 2. The list of commands and the database of recognized gestures is included in the database of the weighing terminal 11. The software of the weighing terminal provides a comparison of the read patterns. The system of non-contact interaction with the operator provides feedback on the status of the terminal program in the form of voice message transmitted through the loudspeaker 17, e.g. regarding the measurement result or other status of the measurement display, menu items, errors, list of possible operations, which allows maintaining the distance between the operator and the balance and limits the interaction only to putting the object on the pan.

The lower housing part has radiation fins on the sides of the lower housing part and on the bottom of the lower housing part. The side ribs with parallel ribs extending from top to bottom extend at least partially beyond the side contour of the upper part of the housing 3, which allows the heat to flow more easily upwards. The lower ribs are made radially in such a way that the ribs have a common point at the center of the lower housing part and extend radially in all directions of the bottom of the lower housing part 4 increasing space between each other as they approach the edge of the terminal, at least for some of the ribs and at least on the part of their length.

1. An electronic static weighing scale with a terminal, comprising an operator identification system and an operator interaction system, a graphic display with a touch panel connected to an upper part of a two-part terminal housing, consisting of upper and lower parts, the lower part of which is at least partially made of heat-conducting material, in which housing a weighing terminal's computer is included in the form of a printed circuit board with a set of interfaces and at least one integrated circuit that requires cooling, an operator identification system, and a contactless operator-device interaction system, characterized in that the inner surface of the lower part (4) of the terminal housing has at least one elevation (10) with a flat surface matching at least one integrated circuit on the computer board of the weighing terminal (8) and the surfaces of the integrated circuits and elevations with a flat surfaces (10) are in contact with each other directly or via a heat-conducting material.

2. The electronic static scale with a terminal according to claim 1, wherein the operator identification system of the weighing terminal (2) consists of an upper housing part (3) and a lower housing part (4) and uses at least one of the sensors such us RFID tag reader (14) and/or a fingerprint reader (13) and/or a camera (12) connected to the computer (8) of the weighing terminal (2).

3. The electronic static scale with a terminal according to claim 2, wherein the operator identification system of the weighing terminal (2) is based on data from the operator database (11) installed on the weighing terminal computer (8).

4. The electronic static scale with a terminal according to claim 1, wherein the system of contactless interaction with the operator in the weighing terminal (2) consists of the upper housing part (3) and the lower housing part (4) and uses at least one of the sensors in the form of a camera (12) and/or a microphone (15) and/or a proximity sensor (16) connected to the computer (8) of the weighing terminal (2).

5. The electronic static scale with the terminal of claim 4, wherein the system of contactless interaction with the operator in the weighing terminal (2) is based on data from the operator database (11) installed on the weighing terminal computer (8).

6. The electronic static scale with a terminal according to claim 1, wherein that the lower part of the housing (4) has at least one adjustable support (7) connected to its lower part, which, resting on a flat surface, forms a space between this surface and the surface of the lower housing part (4).

7. The electronic static balance with a terminal according to claim 6, wherein the lower housing part (4) has radiation fins placed on the sides of the lower housing part and on the bottom of the lower housing part.

8. The electronic static scale with a terminal according to claim 7, wherein the side ribs with parallel ribs extending from top to bottom at least partially extend beyond the side contour of the upper housing part (3).

9. The electronic static balance with a terminal according to claim 7, wherein the lower ribs are made radially in such a way that the ribs have a common point in the center of the lower housing part (4) and extend radially in all directions of the bottom of the lower housing part (4) increasing space between each other as they approach the edge of the terminal, at least for some of the ribs and at least on the part of their length.
